(19) United States
(12) Patent Application Publication
(10) Pub. No.: US 2004/0267790 A1
(43) Pub. Date: Dec. 30, 2004

(54) System to download contents via network

(75) Inventors: Bong-gil Pak, Seoul (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/867,754

(22) Filed: Jun. 16, 2004

Related U.S. Application Data
(60) Provisional application No. 60/478,831, filed on Jun. 17, 2003.

(30) Foreign Application Priority Data
Sep. 9, 2003 (KR) 2003-63408

(51) Int. Cl. G06F 7/00

(52) U.S. Cl. 707/100

(57) ABSTRACT

A system to download contents via a network. A contents service server of the system includes a contents database and a controller. The contents database stores predetermined contents, each having first through N^{th} types of contents suitable for different environments of the client and information related to features of the first through N^{th} types of contents. The controller receives a request to download the predetermined contents and environment information of the client from the client, selects a type of contents of the first through N^{th} types of contents of the predetermined contents suitable for the environment information of the client using the information related to the features of the first through N^{th} types of the predetermined contents, and transmits the selected type of contents to the client.

### CROSS-REFERENCE TO RELATED APPLICATIONS

This application claims the benefit of U.S. Patent Provisional Application No. 60/478,831 filed on Jun. 17, 2003 in the U.S. Patent and Trademark Office, and the priority of Korean Patent Application No. 2003-63408 filed on Sep. 9, 2003 in the Korean Intellectual Property Office, the disclosures of which are incorporated herein in their entirety by reference.

### BACKGROUND OF THE INVENTION

1. Field of the Invention

The present invention relates to a system to download contents via a network, and more particularly, to a system to allow a contents service server to automatically select contents suitable for an environment of a client and transmit the contents to the client.

2. Description of the Related Art

With the advancement of network and data compression technologies, operations to download contents, such as high bandwidth multimedia contents streaming services, etc., have been increasingly widespread. In an environment equipped with a highly interactive user interface like a personal computer (PC), a user can directly select contents to be downloaded based on the environment within which the user's computer is operated, including physical resolution of a display device, data transmission velocity between a contents streaming service server and the user's computer, etc., that is suitable for a contents streaming service.

FIG. 1 shows types of contents stored in an exemplary contents service server. Referring to FIG. 1, the contents service server stores contents #1 and #2. Contents #1 and #2 include a plurality of types of contents a user may download at a minimum data transmission velocity. When the user desires to download the contents #1 in connection with the contents service server, the contents service server provides information shown in FIG. 1 to the user. The user selects one type of contents from the first through third types of contents of the contents #1 based on a data transmission velocity of a data transmission channel installed in the user's computer. Accordingly, the contents service server transmits the selected type of contents to the user.

There have been studies related to adding networking functions to household appliances such as a digital versatile disc (DVD) player, a refrigerator, and/or other similar devices. Household appliances with networking functions are capable of providing data communications with other devices via a network.

However, household appliances with added networking functions, in comparison to PCs, are equipped with limited interactive user interface. In a case where the above-mentioned contents service server provides contents to the household appliances with the networking functions, a user interface similar to the PCs needs to be set up in the household appliances so that a user can directly make a selection to receive contents suitable for the household appliances. Thus, the household appliances need additional personal devices for the user interface, thereby increasing the cost of the household appliances.

Further, the user is more likely to be unfamiliar with the manipulation of the household appliances having added personal devices for the user interface. Thus, the user is inconvenienced because the user is required to have knowledge of the network environment of the household appliances and the specifications of various kinds of pieces of hardware, such as a display device, an audio player, etc., in order to download specific contents. Moreover, the user is more likely to make a mistake during the manipulation of the household appliances in an effort to download the specific contents.

### SUMMARY OF THE INVENTION

According to an aspect of the present invention, a contents service server to select a type of contents suitable for an environment of a client and transmit the selected type of contents to the client, and a method to transmit contents using the contents service server is provided.

According to an aspect of the prevent invention, a client to allow convenient download of a type of contents suitable for the client's hardware and the environment of a network, and a method to download contents using the client is provided.

According to an aspect of the present invention, a contents service server to transmit contents to a client via a network is provided. The contents service server comprises: a contents database to store predetermined contents, each including first through N^{th} types of contents suitable for different environments of the client and information related to features of the first through N^{th} types of contents; and a controller to receive a request to download the predetermined contents and environment information related to the client from the client, where the controller selects a type of contents among the first through N^{th} types of contents of the predetermined contents suitable for the environment of the client using the information related to the features of the first through N^{th} types of the predetermined contents, and transmits the selected type of contents to the client.

According to another aspect of the present invention, a method to transmit contents to a client via a network using a contents service server that stores predetermined contents, each having first through N^{th} types of contents suitable for different environments of the client, and information related to features of the first through N^{th} types of contents is provided. The method comprises: receiving a request to download predetermined contents and environment information related to the client from the client via the network; selecting a type of contents among the first through N^{th} types of contents of the predetermined contents suitable for the environment information related to the client using information related to features of the first through N^{th} types of contents of the predetermined contents; and transmitting the selected type of contents to the client.

According to another aspect of the present invention, a client to download contents from a contents service server via a network is provided. The client comprises, a client environment information storage to store environment information related to the client; and a controller to request the contents service server to download predetermined contents via the network, to transmit the environment information to the contents service server, and to download a type of contents that the contents service server selects from a plurality of types of contents of the predetermined contents suitable for different environments of the client based on the environment information.

According to yet another aspect of the present invention, a method to download contents using a client connected with a network is provided. The method comprises: interfacing with a predetermined contents service server; requesting the predetermined contents service server to download predetermined contents and transmitting environment information related to the client to the predetermined contents service server; and downloading one type of contents the predetermined contents service server selects from a plurality of types of contents of the predetermined contents suitable for different environments of the client with reference to the environment information.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become more apparent, and more readily appreciated from the following description of the embodiments, taken in conjunction with the attached drawings of which:

FIG. 1 is a view to show types of contents stored in a contents service server;

FIG. 2 is a schematic view of a system to download contents via a network according to an aspect of the present invention;

FIG. 3 is a block diagram of a client according to an aspect of the present invention;

FIG. 4 is to show environment information stored in a client according to an aspect of the present invention;

FIG. 5 is a flowchart to explain a method to download contents using a client according to an aspect of the present invention;

FIG. 6 is a block diagram of a contents service server according to an aspect of the present invention;

FIG. 7 is a view to show an example of information of features of contents stored in a contents database; and

FIG. 8 is a flowchart to explain a method to transmit contents using a contents service server according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

FIG. 2 is a schematic view of a system to download contents via a network according to an aspect of the present invention. Referring to FIG. 2, the system includes a contents service server 1 and first through N^{th} clients (3 through 5).

According to an aspect of the present invention, when the contents service server 1 receives requests to download contents and receives environment information from the first through N^{th} clients (3 through 5) via a network 2, the contents service server 1 selects appropriate contents suitable for the first through N^{th} clients (3 through 5). Generally, a user selects contents of a type suitable for the specification of a client and the environment of a network. In contrast, according to an aspect of the present invention, the contents service server 1 selects contents to be transmitted to the first through N^{th} clients (3 through 5) using the environment information related to the first through N^{th} clients (3 through 5).

According to an aspect of the present invention, the contents to be downloaded include audio contents, video contents, a combination of audio and video contents, interactive contents including marked up documents to assign an interactive function to audio and video data, and/or other contents including data files, text files, program files, directory files, etc.

The first through N^{th} clients (3 through 5) request the contents service server 1 to download the contents via the network 2 and transmit the environment information, i.e., information of hardware specification and/or the environment of the network 2, to the contents service server 1. According to an aspect of the present invention, the first through N^{th} clients (3 through 5) are information devices with a networking function, for example, networking-executable DVD players.

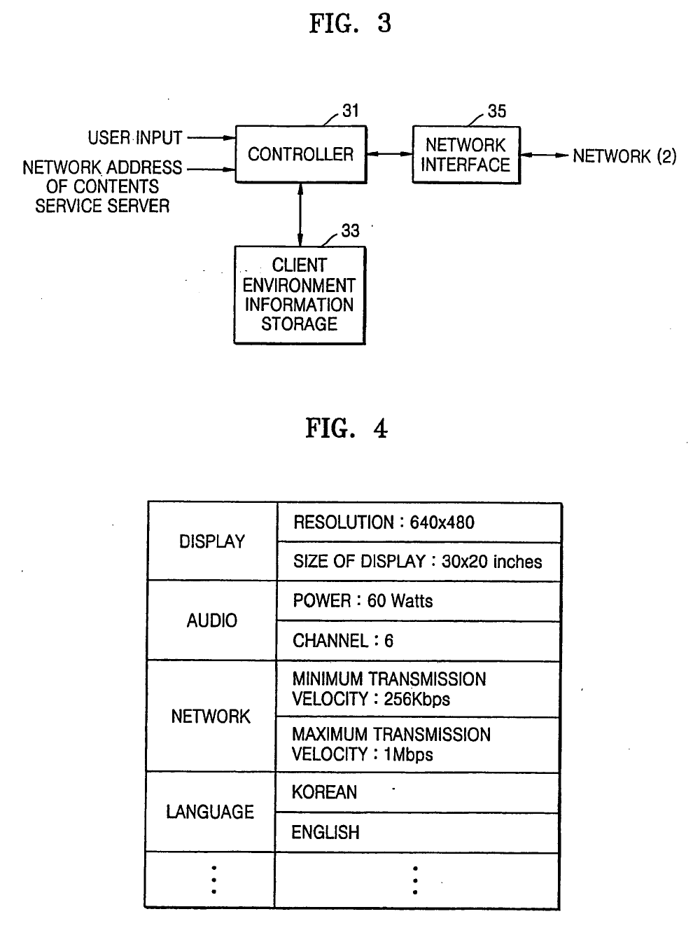

FIG. 3 is a block diagram of a client according to an aspect of the present invention. Referring to FIG. 3, the client includes a controller 31, a client environment information storage 33, and a network interface 35.

The controller 31 controls the client environment information storage 33, and the network interface 35 controls the operation of the client.

The client environment information storage 33 stores environment information related to the client. FIG. 4 illustrates an example of the environment information stored in the client environment information storage 33. Referring to FIG. 4, the environment information includes information related to hardware specification of the client and information related to features of a network.

The information related to the hardware specification of the client includes information related to a display, an audio player, language codes, and the like. The information related to the display includes resolution, physical size, etc., of the display, the information of the audio player includes the number of channels of the audio player and/or the number and power of speakers, and the language codes supportable via the client.

According to an aspect of the present invention, the information of the features of the network refers to information related to data transmission velocities of data transmission channels. According to an aspect of the present invention, the data transmission velocities are classified into minimum and maximum data transmission velocities.

The network interface 35 interfaces with the network 2 in compliance with the control operation of the controller 31.

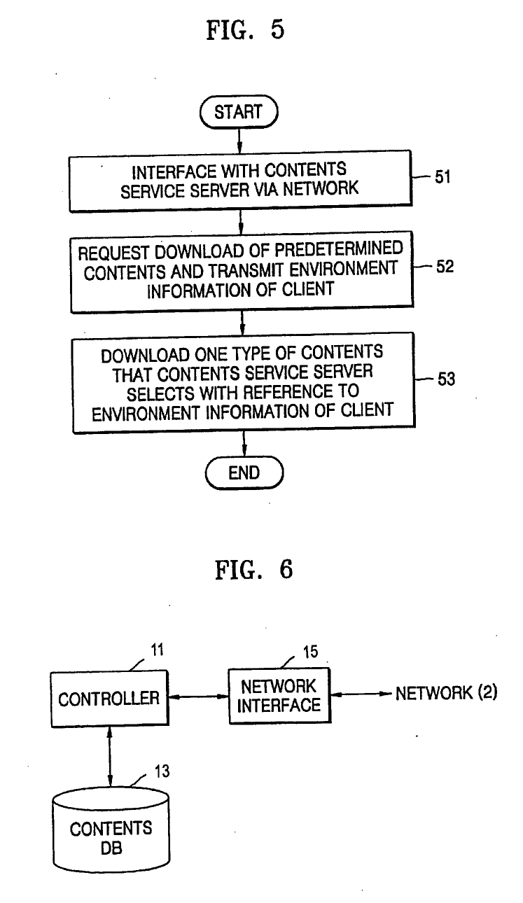

FIG. 5 is a flowchart to explain a method to download contents using the client of FIG. 3. Referring to FIG. 5, in operation 51, the controller 31 of the client interfaces with the contents service server 1 via the network 2 according to a user command to connect to the contents service server 1, and an input network address of the contents service server 1.

The user directly inputs the network address of the contents service server 1 using a user interface of the client. According to an aspect of the present invention, when the client is a DVD player, a DVD on which the network address of the contents service server 1 has been recorded is loaded into the DVD player. The controller 31 then reads the network address of the contents service server 1 from the DVD to interface with the contents service server 1.

In operation 53, the client requests the contents service server 1 to download predetermined contents and transmits the environment information stored in the client environment information storage 33 to the contents service server 1. The environment information includes the information related to the hardware specification and the information related to the features of the network, as shown in FIG. 4.

The contents service server 1 selects a type of contents from a plurality of types of contents of the predetermined contents based on the environment information suitable for the environment of the client. Here, the plurality of types of contents are provided to be adapted to various environments of the client. In operation 55, the client downloads the contents selected by the contents service server 1.

FIG. 6 is a block diagram of the contents service server 1. Referring to FIG. 6, the contents service server 1 includes a controller 11, a contents database (DB) 13, and a network interface 15.

The controller 11 controls the contents DB 13 and the network interface 15 controls the operation of the contents service server 1.

The contents DB 13 stores a plurality of types of contents and information related to features of the plurality of types of contents. According to an aspect of the present invention, the information related to the features of the plurality of types of contents includes information related to hardware specification of the client suitable to execute the contents and/or related to minimum and maximum velocities at which the contents are to be transmitted. As previously described, the information related to the hardware specification of the client includes resolution and physical size of a display of the client, the number of audio channels of the client, language codes that are supportable in the client, and so forth.

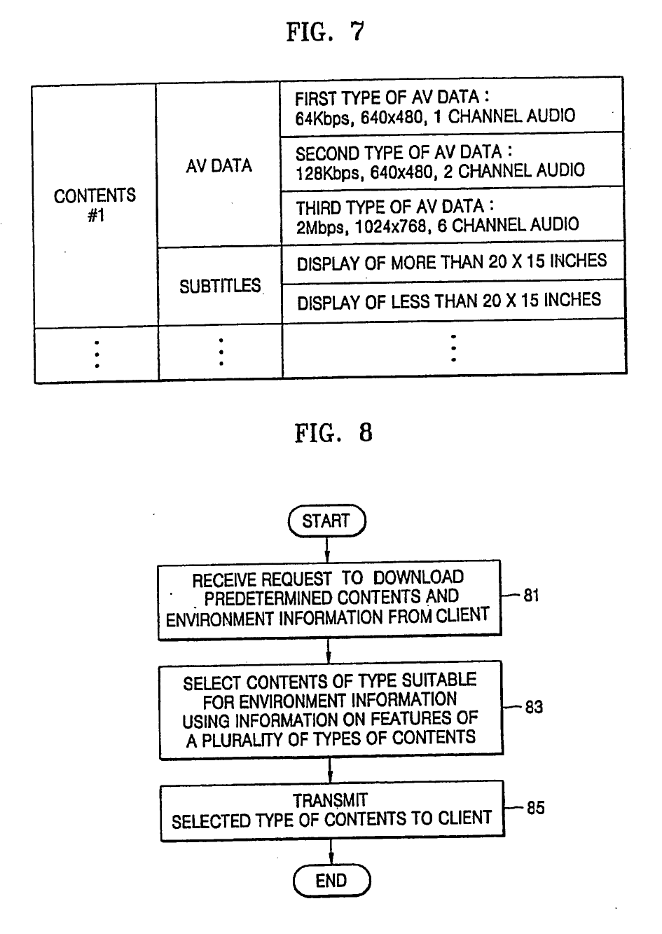

FIG. 7 shows an example of the information related to the features of the plurality of types of contents stored in the contents DB 13. The contents DB 13 stores different types of contents, each of which including a plurality of types of contents with details suitable for the environment of the client, such as the hardware specification of the client and/or the information related to the features of the network 2. Referring to FIG. 7, for example, contents #1 includes three types of AV data.

For example, the first type of AV data is provided based on the environment of the client in which a minimum data transmission velocity is 64 kbps, a display has resolution of 640×480, and where one audio channel is set. Here, the minimum data transmission velocity is related to the quality of video and/or audio of AV data. In other words, the higher the minimum data transmission velocity is, the higher the quality of video and/or audio provided to the client. In comparison between feature information related to the first type of AV data and feature information related to the third type of AV data, the third type of AV data provides higher quality video and/or audio than the first type of AV data.

According to an aspect of the present invention, the contents #1 further includes two types of subtitles according to the physical size of the display of the client. In other words, different types of subtitles are provided depending on whether the display of the client has the physical size of more than or less than 20×15 inches. This is to provide subtitles of a size appropriate for the physical size of the display.

Although not shown, the information related to the features of the plurality of types of contents may further include information related to the number of frames the display displays per second, the number of colors the display represents per second, a color lookup table, the size of an input data buffer of the client, etc.

According to an aspect of the present invention, the network interface 15 interfaces with the network 2 according to the control operation of the controller 11.

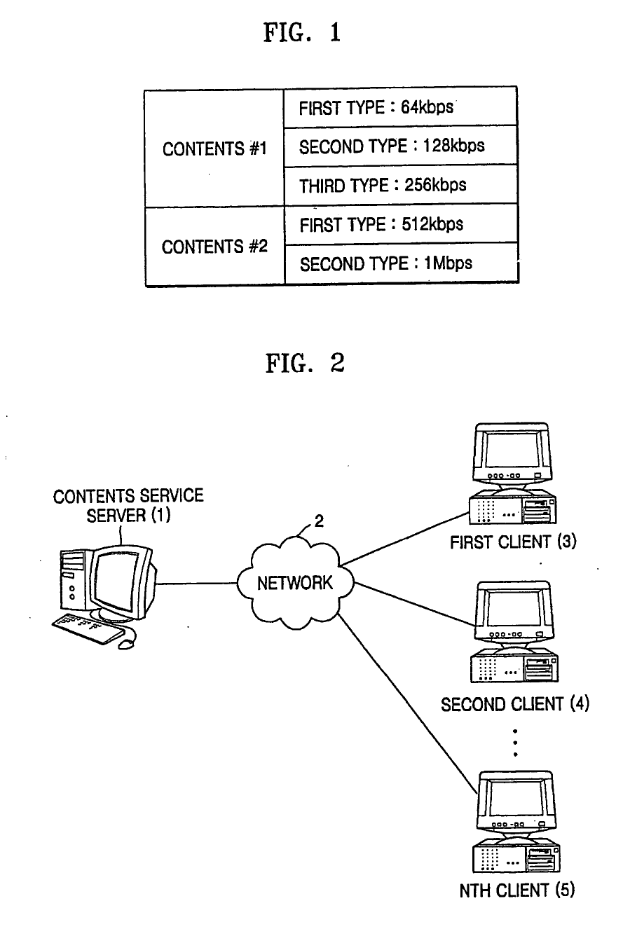

FIG. 8 is a flowchart to explain a method to transmit contents using the contents service server 1 of FIG. 1. Referring to FIG. 8, in operation 81, the controller 11 of the contents service server 1 receives the request to download the predetermined contents and the environment information from the client via the network 2.

In operation 83, the controller 1 selects a type of contents of the plurality of types of contents of the predetermined contents using the information related to the features of the plurality of types of contents of the predetermined contents stored in the contents DB 13. Here, the selected type of contents coincides with the environment information related to the client.

The operation to select one type of contents to be transmitted to the client using the controller 11 will now be explained. For example, in a case where the contents DB 13 stores the information related to the features of the plurality of contents of the predetermined contents as shown in FIG. 7, and the environment information related to the client includes information related to minimum and maximum velocities of 256 kbps and 1 Mbps of the data transmission channels of the client, 640×480 resolution and 30×20 physical size of the display, and six audio channels, the controller 11 compares the information of the features of the plurality of types of contents with the environment information related to the client on an item by item basis.

Considering the velocity of the data transmission channels of the client, the third type of AV data is excluded and the first and second types of AV data have the same resolution, but the second type of AV data has two audio channels. Thus, the controller 11 selects the second type of AV data as suitable for the environment of the client so that the user views high quality contents.

According to an aspect of the present invention, instead of selecting a type of contents suitable for the environment information, the controller 11 selects contents with a small amount of data to reduce an overload in the contents service server 1 due to the concentration of requests for the transmission of contents from a plurality of clients, and transmits the selected contents to the plurality of clients.

In operation 85, the controller 11 reads the selected type of contents from the contents DB 13 and then transmits the selected type of contents to the client via the network interface 15.

As described above, in a system to download contents via a network according to an aspect of the present invention, when a contents service server receives a request to download contents from a client, the contents service server automatically selects contents of a type suitable for hardware of the client and the environment of the network, and transmits the selected type of contents to the client. Thus, a user is able to conveniently download the selected type of contents suitable for the environment of the client. Further, to select the contents, the client does not need to establish a user interface, thereby reducing costs associated with establishing a user interface. Moreover, because the contents service server selects the contents and not the user, the contents service server selects the contents based on the degree of a load therein.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A contents service server to transmit contents to a client via a network, comprising:
a contents database to store the contents, each of the contents having first through N^{th} types of contents suitable for different environments of the client and information related to features of the first through N^{th} types of contents; and
a controller to receive a request to download the contents and environment information related to the client from the client, wherein the controller selects a type of contents among the first through N^{th} types of contents of the contents suitable for the environment information of the client using the information related to the features of the first through N^{th} types of the contents, and transmits the selected type of contents to the client.

2. The contents service server according to claim 1, wherein the information related to the features of the first through N^{th} types of contents comprises:
information related to hardware specification of the client suitable to execute the first through N^{th} types of contents and/or information related to minimum data transmission velocities of the first through N^{th} types of contents.

3. The contents service server according to claim 1, wherein the environment information of the client includes information related to the hardware specification of the client and/or information related to data transmission velocity of a data transmission channel established using the client.

4. The contents service server according to claim 2, wherein the information related to the hardware specification of the client comprises:
resolution information related to a display of the client, a physical size of the display, the number of speakers connected with the client, and/or a language code supportable using the client.

5. The contents service server according to claim 1, wherein the controller selects the type of contents of the first through N^{th} types of contents of the predetermined contents based on a degree of a load in the network and transmits the selected type of contents to the client.

6. A method to transmit contents to a client via a network using a contents service server that stores contents having first through N^{th} types of contents suitable for different environments of the client and information related to features of the first through N^{th} types of contents, comprising:
receiving a request to download contents and environment information related to the client from the client via the network;
selecting a type of contents of the first through N^{th} types of contents of the contents suitable for the environment information related to the client using information related to features of the first through N^{th} types of contents; and
transmitting the selected type of contents to the client.

7. The method according to claim 6, wherein the information related to the features of the first through N^{th} types of contents comprises:
information related to hardware specification of the client suitable to execute the first through N^{th} types of contents and/or information related to minimum data transmission velocities of the first through N^{th} types of contents.

8. The method according to claim 6, wherein the environment information related to the client comprises:
information related to the hardware specification of the client and/or information related to data transmission velocity of a data transmission channel established using the client.

9. The method according to claim 8, wherein the information related to the hardware specification of the client comprises:
resolution information of a display of the client, a physical size of the display, the number of speakers connected with the client, and/or a language code that is supportable using the client.

10. The method according to claim 6, wherein the type of contents of the first through N^{th} types of contents among the contents is selected based a degree of a load in the network.

11. A client to download contents from a contents service server via a network, comprising:
a client environment information storage to store environment information of the client; and
a controller to request the contents service server to download contents via the network, to transmit the environment information of the client to the contents service server, and to download a type of contents the contents service server selects from a plurality of types of contents of the contents suitable for different environments of the client with reference to the environment information of the client.

12. The client according to claim 11, wherein the environment information of the client includes information related to hardware specification of the client and/or information related to data transmission velocity of a data transmission channel established in the client.

13. The client according to claim 12, wherein the information related to the hardware specification of the client includes at least one of resolution of a display of the client, a physical size of the display, the number of speakers connected to the client, and a language code that is supportable in the client.

14. A method to download contents using a client connected with a network, comprising:
interfacing the client with a contents service server;
requesting the contents service server to download contents and transmitting environment information related to the client to the contents service server; and
downloading a type of contents the contents service server selects from a plurality of types of contents of the predetermined contents suitable for different environments of the client with reference to the environment information related to the client.

15. The method according to claim 14, wherein the environment information of the client includes information related to hardware specification of the client and/or information related to data transmission velocity of a data transmission channel established in the client.

16. The method according to claim 15, wherein the information related to the hardware specification of the client includes at least one of resolution of a display of the client, a physical size of the display, the number of speakers connected to the client, and a language code that is supportable in the client.

18. The contents service server according to claim 3, wherein the information related to the data transmission velocity of the data transmission channel is classified into supportable minimum and maximum data transmission velocities.

19. The contents service server according to claim 1, further comprising:
network interface to connect the client with the contents service server.

20. The contents service server according to claim 1, wherein the contents stored in the contents database includes audio and/or video contents.

21. The contents service server according to claim 1, wherein the client is a digital versatile disc player.

22. The contents service server according to claim 1, wherein the information related to features of the first through N^{th} types of contents includes information related to a number of frames a display of the client displays per second, and/or a number of colors the display of the client represents per second.

23. The contents service server according to claim 6, wherein the contents stored in the contents service server includes audio and/or video contents.

24. The contents service server according to claim 1, wherein the contents service server compares the information related to the features of the first through N^{th} types of contents with the environment information related to the client to select and transmit the type of contents among the first through N^{th} types of contents.

25. A method to transmit contents to clients via a network using a contents service server, comprising:
automatically selecting a type of contents suitable for an environment of the client from stored types of contents using environment information related to the client and the network; and
transmitting the selected contents to the client via the contents service server.

26. The method according to claim 25, wherein the environment of the client includes information related to hardware specification of the client and/or information related to data transmission velocity of a data transmission channel established via the client.

27. A contents service server to transmit contents to clients via a network, comprising:
a database to store contents, the contents having information suitable for different environments of the clients and information related to features of the contents; and
a controller to control respective download of the contents to the clients, wherein the controller automatically selects corresponding contents from the stored contents suitable for environment of the clients using information related to features of the contents and transmits the selected type of content to the clients.

28. The contents service server according to claim 27, wherein the controller selects contents having a small amount of data.

29. The contents service server according to claim 27, wherein information related to the features of the contents comprises information related to a number of frames a display of the clients displays per second, a number of colors a display of the clients represents per second, a color lookup table, and/or a size of an input data buffer of the client.

30. A method to transmit contents to clients via a network using a contents service server, comprising:
storing respective environment information of the clients and environment information of the network; and
correspondingly transmitting the contents to the clients based on the respective environment information of the clients and the environment information of the network, wherein the contents service server automatically selects corresponding contents to be transmitted to the clients.

31. A method to transmit contents to clients via a network using a contents service server, comprising:
transmitting environment information including data related to hardware specification of the clients and/or environment information of the network to the contents service server; and
downloading contents to the clients based on environment information of the clients and/or environment information of the network, wherein the contents service server selects corresponding contents to be downloaded to the clients.

32. A system to download data to a client via a network using a contents service server, comprising:
a database to store data to be downloaded including data compatible with different environments of the client and information related to features of the data;
a first controller provided to the client to request a download of data and to transmit environment information of the client to the contents service server; and
a second controller provided to the contents service server to transmit data, wherein the contents service server automatically selects and transmits data based on the environment information of the client and information related to features of the data.
